(19) United States
(12) Patent Application Publication
(10) Pub. No.: US 2013/0035449 A1
(43) Pub. Date: Feb. 7, 2013

(54) METHOD FOR PREPARING BIODEGRADABLE POLYMER MATERIALS, BIODEGRADABLE POLYMER MATERIALS AND PRODUCT FOR FIXING BONE

(71) Applicants: Young Mee JUNG, Seoul (KR); Soo Hyun Kim, Seoul (KR); Sang Heon Kim, Seoul (KR); Young Ha Kim, Seoul (KR)

(72) Inventors: Young Mee JUNG, Seoul (KR); Soo Hyun Kim, Seoul (KR); Sang Heon Kim, Seoul (KR); Young Ha Kim, Seoul (KR)

(73) Assignee: KOREA INSTITUTE OF SCIENCE AND TECHNOLOGY, Seoul (KR)

(21) Appl. No.: 13/566,483

(22) Filed: Aug. 3, 2012

(30) Foreign Application Priority Data
Aug. 4, 2011 (KR) 10-2011-0077924

(51) Int. Cl. B29C 47/00; C08L 67/04

(52) U.S. Cl. 525/450; 264/176.1

(57) ABSTRACT

Disclosed are a method for preparing biodegradable polymer materials, biodegradable polymer materials, and a product for fixing bone. The method includes a complex preparing step of preparing polylactide stereoisomeric complex by using a polymer having weight-average molecular weight more than 100,000 g/mol; a molding step of compression-molding the complex; a cooling step of cooling the compression-molded complex; and an extruding step of solid state extruding the cooled complex. Biodegradable polymer materials prepared by the method may be applied to a product for fixing bone or spine requiring high strength. Biodegradable polymer materials may have no corrosion in the body, may require no additional operation for removal after healing bones and tissues, and may prevent stress shielding.

### CROSS-REFERENCE TO RELATED APPLICATION

This application claims the benefit of Korean Patent Application No. 10-2011-0077924, filed on Aug. 4, 2011, which is hereby incorporated by reference for all purposes as if fully set forth herein.

### BACKGROUND OF THE INVENTION

1. Field of the Invention

The present invention relates to a method for preparing biodegradable polymer materials, biodegradable polymer materials, and a product for fixing bone, and more particularly, to a method for preparing biodegradable polymer materials is capable of preventing corrosion in the body, requiring no additional operation for removal after healing bones and tissues, and preventing stress shielding when being applied to a product for fixing bone, due to small molecular weight loss during processing, and due to biodegradability and high strength greater than that of cortical bone, biodegradable polymer materials, and a product for fixing bone.

2. Background of the Invention

Recently, biodegradable polymer materials are applied to medical fields in various ways, the materials configured to heal the body and having a characteristic to become extinct in the body by metabolism after having fulfilled its purpose.

The biodegradable polymer materials have the following advantages when compared with metallic and ceramic materials.

Firstly, the polymer materials do not corrode within the body, and require no additional operation for removal after healing bones and tissues. Furthermore, the metallic and ceramic materials cause stress shielding of the bone, a phenomenon in which a bone after fracture/injury does not completely regain its strength since strength of the metallic and ceramic materials is greater than that of the bone. On the other hand, biodegradable polymer materials can be gradually degraded as injury is healed. Therefore, biodegradable polymer materials may help newly-generated soft or hard tissues to gradually regain sufficient strength and function.

Recently, research on biodegradable polymer materials is actively developing. Among a plurality of synthesized biodegradable polymer materials, aliphatic polyester is being researched the most widely due to its excellent physical property and hydrolysis characteristic.

Among the aliphatic polyesters, representative synthesized biodegradable polymer materials, such as polyglycolide or polyglycolic acid (PGA), L-polylactide or polylactic acid (PLA), their copolymers, etc., are being frequently used as suture threads for operation, which are materials for fixing soft and hard tissues, materials for fixing orthopedic and plastic surgeon tissues, and as a drug delivery system.

The aliphatic polyester-based synthesized biodegradable polymer materials have different strengths and degradation periods depending on structural form.

PGA has high strength with a tensile elastic modulus of about 7 GPa, due to simple chemical structure and high crystallinity. However, PGA is rapidly degraded due to a high hydrophilic property. The PGA has a period of about 1 month for which strength is maintained in the body, and can remain in the body until complete degradation for a period of about 3 months.

Poly(L-lactide) (PLLA) has a tensile elastic modulus of about 1.6 GPa due to crystallinity lower than that of the PGA. However, PLLA is more slowly degraded due to its high hydrophobic property. Therefore, PLLA has a period of about 6 to 12 months for which strength is maintained in the body, and can remain in the body until complete degradation for a period of about 1 to 3 years.

However, the aliphatic polyester-based synthesized biodegradable polymer materials are substantially applied only to parts meant for supporting a small load pressure, due to its weaker strength than those of the metallic and ceramic materials.

Namely, the currently-commercialized supporter for fixing bone is applied is only to parts which receive a small load pressure. For instance, the product is applied to interference screws for fixing the ankle, knee, hand, etc. [Bioscrew (Registered trade name) manufactured by Linvatec, Arthrex (Registered trade name) manufactured by Arthrex, SmartScrew (Registered trade name) manufactured by Bionx, etc.], tacks or pins for fixing ligament or semilunar bone [SmartTack (Registered trade name) manufactured by Bionx, Biofix (Registered trade name) manufactured by Bionx], plates and screws for fixing suture threads, screws and plates for craniomaxillofacial fixation [LactoSorb (Registered trade name) manufactured by Lorenz], etc.

However, it has not been reported that the supporter for fixing bone has strength high enough to be applied to part such as the femur or the spine where a large load has to be supported.

In order to prepare and apply the PLA stereoisomer complex, several problems have to be solved. The PLA stereoisomer complex has to be prepared by solution casting using an organic solvent. If the PLA has weight-average molecular weight less than about 100,000 g/mol, a stereoisomer complex is easily formed. On the other hand, if the PLA has a large molecular weight, a stereoisomer complex is scarcely formed. Furthermore, it takes a lot of time to completely remove the solvent after the stereoisomer complex has been prepared. [Tsugi et al., Macromolecules, 25, 4144 (1992); Fukushima et al., Macromol. Symp., 224, 133 (2005)].

In case of preparing the PLA stereoisomer complex by direct melt mixing method or a bulk polymerization method, the following problems may occur. In particular, there is a limitation in molecular weight, and stereoisomer complex is not easily formed due to crystallization of a single crystalline polymer. Furthermore, thermal degradation of the PLA may result when the PLA stereoisomer complex is melted at a high temperature of higher than 200° C. [Tsugi at al., Macromol. Biosci., 5, 569 (2005)]. For these reasons, research is actively ongoing for development of a novel method for preparing a PLA stereoisomer complex having high molecular weight and high strength.

An aliphatic polyester, such as PLA and PGA, has a great amount of breakup of molecular chains by thermal degradation due to low heat resistance, when undergoing melt processing such as extrusion, injection-molding and compression-molding, general polymer molding processing. Consequently, there occurs a molecular weight loss of the polymer, resulting in a lowering of final strength [Refer to the literature by S. Gogolewski et al., Polym. Deg. Stab., 40, 313(1993)].

Accordingly, for the purpose of enhanced processing method, other approaches, such as self-reinforcing, solid state extrusion, etc. have been developed.

PGA or PLLA screws or pins prepared by self-reinforcing have been presented on the market. However, the screws or pins do not have sufficient strength [Biofix (Registered trade name) and SmartScrew (Registered trade name) each manufactured by Bionx].

Solid state extrusion has been developed to enhance the physical property of a non-degradable polymer such as polyethylene, polypropylene and polyamide. Solid state extrusion serves to increase crystallinity and the degree of orientation by draw-orienting molecular chains in a uniaxial direction, by using hydrostatic pressure or ram extrusion or die extrusion at temperature higher than a glass-transition temperature of a polymer but lower than melting point of a polymer. Consequently, solid-state extrusion serves to significantly enhance strength of a polymer. Since processing is performed at a temperature lower than melting point of a polymer, breaking of molecular chains by thermal degradation may be significantly reduced compared to general melting processing. This may reduce the weakening of the polymer.

Once molecular chains are cut, molecular weight and the number of molecular entanglements are reduced. This results in lowering of strength of the polymer. For instance, according to research by Ferguson et al., a billet prepared by melt-extruding PLLA undergoes solid state extrusion in the form of die extrusion. This resulted in a flexural strength of 215 MPa greater than strength of cortical bone, and flexural modulus of elasticity of 13.7 GPa. This research demonstrates that molecular weight loss was prevented and strength of the polymer was enhanced during solid state extrusion. However, during melt extrusion for preparing a billet used in solid state extrusion, viscosity-average molecular weight was reduced by more than 50% from 415,000 to 200,000 g/mol, due to great thermal degradation [Refer to the literature by S. Ferguson et al., J. Biomed. Mater. Res., 30, 543(1996)].

Furthermore, Weiler and Gogolewski have obtained flexural strength of 200 MPa and flexural modulus of elasticity of 9 GPa by solid state extruding PDLA, a PLLA stereoisomer. However, during melt extrusion for preparing a billet, to viscosity-average molecular weight was reduced by about 40% from 280,000 to 160,000 g/mol due to thermal degradation [Refer to the literature by W. Weiler and S. Gogolewski, Biomaterials, 17, 529(1996)].

The above research was performed by using biodegradable aliphatic group polyesters having high molecular weight corresponding to viscosity-average molecular weight of 280,000 to 500,000 g/mol, with consideration of thermal degradation during processing when preparing biodegradable polymer materials for fixing bone, and with consideration of a supporting period in the body. However, molecular weight of a final supporter was reduced by 40% or more when compared with the initial molecular weight, due to processability.

3. Prior Art

### Non-Patent Literatures

1. Tsugi et al., Macromolecules, 25, 4144 (1992), Fukushima et al., Macromol. Symp., 224, 133 (2005).
2. W. Weiler, S. Gogolewski, Biomaterials, 17, 529(1996).

### SUMMARY OF THE INVENTION

The goal of this invention is to provide a method for preparing biodegradable polymer materials, biodegradable polymer materials, and a product for fixing bone, the biodegradable polymer materials capable of being applied to materials for fixing bone including the spine, etc. which requires high strength, due to small molecular weight loss during processing, and due to biodegradability and high strength greater than that of cortical bone.

To achieve these and other advantages and in accordance with the purpose of this specification, as embodied and broadly described herein, there is provided a method for preparing biodegradable polymer materials, the method comprising: a complex preparing step of preparing polylactide stereocomplex by using a polymer having weight-average molecular weight more than 100,000 is g/mol; a molding step of compression-molding the complex; a cooling step of cooling the compression-molded complex; and an extruding step of solid state extruding the cooled complex.

The polymer may be categorized into a D-type polymer and an L-type polymer, and its constituents may include a cyclic ester monomer having chiral carbon.

The cyclic ester monomer may be selected from a group consisting of lactides, lactones, cyclic carbonates, cyclic anhydrides, thiolactones and a combination thereof.

The cyclic ester monomer may be one or more selected from a group consisting of a compound represented by the following Chemical Formula 1,

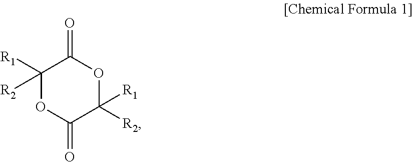

wherein the R₁ and R₂ are independently selected from a group consisting of hydrogen and an alkyl group of carbon each having the number of 1 to 4.

The polymer may include one selected from a group consisting of PLLA(L-polylactide), PDLA(D-polylactide), PGA(polyglycolide), PLLA/PGA(polyglycolic acid), PDLA/PGA, PLLA/PCL(polycaprolactone), PDLA/PCL and a combination thereof.

The polymer may have weight-average molecular weight of 100,000 to 1,000,000 g/mol.

In the complex preparing step, complex may be prepared by using a solvent, in a supercritical fluid system having a temperature of 25 to 250° C. and an atmospheric pressure of 40 to 700 bar.

In the molding step, a compression-molding temperature may be in the range of 150 to 280° C.

In the step of cooling, a cooling speed for cooling the compression-molded complex may be in the range of 1 to 100° C./min.

In the step of cooling, the compression-molded complex may be cooled to 20 to 150° C.

In the step of extruding, a discharge part of the die of the solid state extruder may have a diameter of 1 to 20 mm.

In the step of extruding, the solid state extrusion may be performed by setting an incident angle of the die to 5 to 60°.

In the step of extruding, an extrusion temperature may be in the range of 40 to 170°C.

In the step of extruding, an extrusion pressure may be in the range of 5,000 to 30,000 lb/in².

In the step of extruding, a draw rate may be two or more.

In the step of extruding, a draw speed may be in the range of 5 to 300 mm/min.

To achieve these and other advantages and in accordance with the purpose of this specification, as embodied and broadly described herein, there is also provided biodegradable polymer materials prepared by the method for preparing thereof.

The degradable polymer materials may have molecular weight loss less is than 20%, flexural strength of 200 to 400 MPa, and flexural modulus of elasticity of 5 to 20 GPa.

To achieve these and other advantages and in accordance with the purpose of this specification, as embodied and broadly described herein, there is still also provided a product for fixing bone, the said product having biodegradable polymer materials, and configured to fix bones and tissues including the spine and femur (thighbone).

The product for fixing bone may be selected from a group consisting of a rod, plate, pin and screw.

Hereinafter, the present invention will be explained in more details.

A method for preparing biodegradable polymer materials according to one embodiment of the present invention comprises a complex preparing step, a molding step, a cooling step and an extruding step.

In the complex preparing step, polylactide stereocomplex may be prepared by using a polymer having weight-average molecular weight more than 100,000 g/mol.

The polylactide stereocomplex may be prepared by using the polymer, the polymer may be categorized into a D-type polymer and an L-type polymer, and its constituents may include a cyclic ester monomer having chiral carbon.

Preferably, the biodegradable polymers used in the present invention may be a polymer polymerized from a cyclic ester monomer. More preferably, the biodegradable polymers used in the present invention may be a biodegradable polyester, such as an aliphatic polyester or copolymerized polyester. The cyclic ester monomer may be one or more selected from lactides, lactones, cyclic carbonates, cyclic anhydrides and a thiolactones compound. The included monomers may be a cyclic ester having chiral carbon.

The cyclic ester monomer may be preferably one or more selected from a group consisting of a compound represented by a following chemical formula 1, and more preferably lactides selected from the compound represented by the following chemical formula 1,

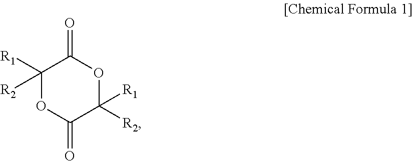

wherein the R₁ and R₂ are independently selected from a group consisting of hydrogen and an alkyl group of carbon each having the number of 1-4.

The complex may be prepared by using a polymer including one selected from a group consisting of PLLA, PDLA, PGA, PCL and a combination thereof.

The polymer may be one selected from a group consisting of PLLA and a copolymer thereof, PDLA and a copolymer thereof, and a combination thereof.

The polymer may be a copolymer selected from a group consisting of PLLA, PDLA, PGA, PLLA/PGA, PDLA/PGA, PLLA/PCL, PDLA/PCA and a combination thereof, and the polymer may consist of PLLA and PDLA.

PLA may include L-type and D-type stereoisomers having opposite configurations. The stereoisomers may have the same chemical structure and property, but have configurations symmetrical to each other as mirror images.

Namely, PLLA may have a left-handed spiral structure, and PDLA may have a right-handed spiral structure. Once the two polymers are uniformly mixed with each other, polymer chains may be laminated in parallel. This may result in a stereoisomer complex having a new crystalline structure.

The stereoisomer complex may have a high melting point due to very high crystallinity, and therefore, may have enhanced heat-resistance and mechanical strength qualities.

The PLA stereoisomer complex may be prepared by using PLLA and PDLA having a weight ratio of 0.5:1.5 to 1.5:0.5, or a weight ratio of 0.8:1.2 to 1.2:0.8.

Weight-average molecular weight of the polymer measured by gel-permeation chromatography may be more than 100,000 g/mol, or may be in the range of 100,000 to 1,000,000 g/mol.

In the complex preparing step, complex may be prepared by using a solvent in a supercritical fluid system.

The solvent may be an organic solvent, and more concretely, may be one selected from a group consisting of chloroform, dichloromethane, dioxane, toluene, xylene, ethyl benzene, dichloroethylene, dichloroethane, trichloroethylene, chlorobenzene, dichlorobenzene, tetrahydrofuran, dibenzylether, dimethylether, acetone, methylethylketone, cyclohexanone, acetophenone, methylisobutylketone, isophorone, diisobutylketone, methylacetate, ethyl formate, ethylacetate, diethylcarbonate, diethylsulfate, butylacetate, diacetone alcohol, diethylglycol monobutylether, decanol, benzene acid, stearic acid, tetrachloroethane, hexafluoroisopropanol, hexafluoroacetone, sesquihydrate, acetonitrile, chlorodifluoromethane, trifluoroethane, difluoromethane and a combination thereof.

The supercritical fluid system may be configured to introduce a supercritical fluid at a temperature of 25 to 250° C. and at an atmospheric pressure of 40 to 700 bar.

The supercritical fluid may be one selected from a group consisting of carbon dioxide (CO₂), dichlorotrifluoroethane (HFC-23), difluoromethane (HFC-32), difluoroethane (HFC-152a), trifluoroethane (HFC-143a), tetraflouroethane (HFC-134a), pentafluoroethane (HFC-125), heptafluoropropane (HFC-227ea), hexafluoropropane (HFC-236fa), pentafluoropropane (HFC-245fa), sulfur hexafluoride (SF₆), perfluorocyclobutane (C-318), chlorofluoroethane (HCFC-1416), chlorodifluoroethane (HCFC-1426), dimethylether, nitrogen oxide (NO₂), propane, butane and a combination thereof.

The supercritical fluid system may be operated at a temperature of 25 to 250° C., and preferably at a temperature of 25 to 150° C. The supercritical fluid system may be operated at an atmospheric pressure of 40 to 700 bar, and preferably at an atmospheric pressure of 100 to 400 bar.

When the complex is prepared in the supercritical fluid system, a reaction may be rapidly performed, thereby reducing the extant solvent amount. This may simplify the preparation processes.

Furthermore, when the polylactide stereocomplex is prepared by the method, the complex may have enhanced crystallinity and reduced solubility. This may allow the collection of complex precipitated in the form of particles or a small mass.

In the complex preparing step, the solvent may have a content of 0.5 to 100 wt % based on content of the supercritical fluid of 100 wt %.

In the complex preparing step, the polymer may have a content of 1 to 50 wt % based on content of a mixture between the supercritical fluid and the solvent of 100 wt %.

The polylactide stereocomplex may have a melting point higher than that of PLLA or PLDA, and may have superior mechanical property, such as flexural modulus of elasticity, flexural strength and elongation at break.

The molding step may include a step of compression-molding the complex.

The compression-molding may be performed by putting the complex in a mold, putting the mold in a vacuum bag formed of a film for high temperature and high pressure, and by compression-molding the mold.

The compression-molding may be performed in a temperature range where the polymer can be melted, namely in the range of 150 to 280° C., but preferably 170 to 250° C.

If the temperature of the compression-molding exceeds 280° C., the polymer may be greatly thermally-degraded. On the other hand, if the temperature is less than 150° C., the polymer may not be sufficiently melted. This may cause a difficulty in obtaining compression-molded materials uniform enough to prepare a billet.

The compression-molding may be performed for 10 min to 5 hours, but preferably for 30 min to 3 hours.

The cooling step may include a step of cooling the compression-molded complex.

A microstructure of the compression-molded complex may be determined according to the conditions of the cooling step. Specifically the rate of the cooling step may be in the range of 1 to 100° C., but preferably 5 to 30° C./min.

In the cooling step, a cooling target temperature may be in the range of 20 to 200° C. at room temperature, or preferably, in the range of 20 to 180° C. at room temperature. Once the current temperature reaches the cooling target temperature, the compression-molded complex may be left at room temperature of 20° C.

During the compression-molding, the cooling speed and target temperature influence each other, and may greatly influence the microstructure of compression-molded polymer materials, especially, the degree of crystallization [Refer to U. W. Gedde, Polymer Physics, Chapman & Hall, Chapter 8(1995)].

If the compression-molded polymer materials are cooled with a speed lower than the cooling speed, it may take a long time to reach the cooling target temperature. This may cause an additional crystallization behavior, resulting in a difficulty in controlling the microstructure of compression-molded polymer materials. On the other hand, if the compression-molded polymer materials are cooled with a speed greater than the cooling speed, desired crystallinity may not be obtained.

The cooling target temperature may be controlled within the range of the target temperature according to desired crystallinity of compression-molded polymer materials. Since the temperature, which affects a crystallization behavior when the polylactide stereocomplex is cooled, is in the range of about 100 to 190° C., cooling the compression-molded polymer materials to the target temperature out of the temperature range may not be differentiated from the condition, but may be included in the condition. In the present invention, may be prepared compression-molded complex having crystallinity of 5 to 50%, a desired to degree of crystallization, through a combination of the two conditions.

Furthermore, weight-average molecular weight of the compression-molded material prepared by vacuum compression-molding used in the present invention exhibited molecular weight loss less than about 10% when compared to the initial weight-average molecular weight of the used PLA stereoisomer complex, regardless of the morphology of the compression-molded materials. This may minimize lowering of thermal degradation and molecular weight loss of polymers to be processed.

The compression-molded complex exhibited brittle fracture as a result of a three-point flexural test. And, flexural strength and flexural modulus of elasticity of the complex have gradually increased marginally according to the increase of crystallinity.

Generally, the higher the crystallinity level of a polymer material is, the greater the strength of the polymer material becomes. However, the compression-molding is a crystallization process which causes no orientation of polymer molecular chains, and generated crystals have a spherulite structure, an isotropic structure. Therefore, it may be inferred that the strength difference of a polymer material according to crystallinity is not significant.

The extruding step may include a process of solid state extruding the cooled complex.

The process of solid state extruding may include a process of preparing the cooled complex in the form of a billet, and a process of solid state extruding the billet by using a solid state extruder.

The process of preparing the cooled complex in the form of a billet may be performed, and a billet formed in a cylindrical shape may be processed so that the end thereof can have the same angle as an incident angle (an angle from a central axis) of a die of a solid state extruder.

The billet may have a diameter of 2 to 30 mm, and preferably a diameter of 3 to 20 mm.

The billet may be a solid state extruded through the solid state extruder. A discharge part of the die of the solid state extruder may have a diameter of 1 to 20 mm, but preferably a diameter of 1.5 to 10 mm.

The diameter of the discharge part of the die may correspond to a diameter of a solid state extruded rod. Therefore, the diameter of the discharge part of the die may be determined with consideration of processability and a usable probability of a rod in the body.

If the diameter of the discharge part of the die is out of the range, the solid state extruded rod may have a limitation in being used as a bone fixing material, due to the thickness being either too small or great. Furthermore, it may be difficult to apply a hydrostatic pressure and external tensile force with regard to processability.

An incident angle of the die of the solid state extruder may be in the range of 5 to 60°, but preferably in the range of 10 to 30°.

The most important factor to determine the geometry of the solid state extruder may be the processability and drawing efficiency by solid state extrusion. Generally, the processability and drawing efficiency may be contrary to each other. That is, when an incident angle of the die is increased, the drawing efficiency increases, provided that the die has the same length. This may enhance molecular orientations inside the solid state extruded materials. However, performing solid state deformations may be difficult as the incident angle of the die is increased.

Therefore, when the incident angle of the die is less than the incident angles of the predetermined range, a draw efficiency may be lowered. On the other hand, when the incident angle of the die is larger than the incident angles of a predetermined range, processability may be significantly lowered.

In the extruding step, the solid state extrusion may be performed by filling oil into the solid state extruder, and by increasing the temperature of the oil to greater than the glass-transition temperature of the used PLA stereoisomer complex, but less than the melting point thereof.

Temperature inside the solid state extruder may be in the range of 40 to 195° C., preferably in the range of 80 to 190° C., and optimally in the range of 100 to 185° C.

As a biodegradable polymer, the PLA stereoisomer complex, may have a glass-transition temperature of 70° C. and a melting point of 230° C. Accordingly, a solid state extrusion temperature range may be preferably set between these two temperature points.

If the temperature inside the solid state extruder is lower than the minimum temperature of a predetermined range, processability of solid state extrusion may be significantly lowered. On the other hand, if the temperature inside the solid state extruder is higher than the maximum temperature of a predetermined range, extruded materials may be partially melted.

The rate of temperature-rise to the solid state extrusion temperature may be in the range of 1 to 20° C./min, but preferably in the range of 2 to 10° C./min.

The billet may be configured to perform solid state extrusion in a fitted state into the die of the solid state extruder, by applying a hydrostatic pressure and external tensile force, when the temperature of the oil which encompasses the billet reaches a suitable temperature for solid state extrusion.

The hydrostatic pressure for solid state extrusion may be in the range of 5,000 lb/in²˜30,000 lb/in², and preferably in the range of 10,000 lb/in²˜20,000 lb/in². The hydrostatic pressure applied to the billet in the solid state extruder may be determined according to a capacity of the solid state extruder, geometry of the die, etc. If the hydrostatic pressure is less than 5,000 lb/in², it may be difficult to perform solid state extrusion. On the other hand, if the hydrostatic pressure is more than 30,000 lb/in², stability of processing may be lowered.

In the extruding step, a draw speed may be in the range of 5 to 300 mm/min, but preferably in the range of 10 to 200 mm/min. The draw speed may be determined in the range which does not degrade processability and uniformity of processing. If the draw speed is less than 5 mm/min, the productivity may be lowered too much. On the other hand, if the draw speed is more than 300 mm/min, a thickness of a solid state extruded material may significantly decrease, or the solid state extruded material may be cut during the solid state extrusion.

A draw rate during solid state extrusion may be calculated from an area ratio between a billet and an extruded rod as shown in the following Formula 1. Generally, as a draw rate is increased, dynamics of extruded polymer materials are enhanced. In the present invention, a draw rate may be increased by a factor of two or more in order to satisfy strength conditions required at various parts in the body. Alternatively, the draw rate may be increased to 2 to 6, or 2.5 to 5.

Draw rate=D_{b}²/D_{f}² [Formula 1]

In the Formula 1, D_{b} denotes a diameter of a billet, and D_{f} denotes a diameter of a solid state extruded rod.

In the molding step, the compression-molded complex exhibited very small molecular weight loss. The biodegradable polymer materials prepared by extruding the billet prepared by using the compression-molded complex exhibited small loss of weight-average molecular weight, 10% or less when compared with the initial weight-average molecular weight, in all the processing, regardless of billet crystallinity, a draw rate change according to a billet thickness, or a draw speed change. This means that the biodegradable polymer materials of the present invention exhibited molecular weight loss much smaller than that of the conventional polymer materials corresponding to 40% or more.

The biodegradable polymer materials prepared by the method for preparing biodegradable polymer materials may be maintained in an extrusion temperature range for several minutes to several tens of minutes in the extruding step. This may result in thermally-induced crystallization in the solid state extruder. The reason is because the solid state extrusion temperature is in the range between the glass-transition temperature and that of the melting point, where cold crystallization occurs as measured by differential scanning calorimetry (DSC) on the PLA stereoisomer complex.

The crystallinity of the billet (5% to 50%) obtained in the molding step increased to 20 to 60% according to the solid state extrusion temperature and rate of temperature-rise, as a result of the thermally-induced crystallization after the extruding step. Here, the increase of an orientation degree due to the increase of the crystallinity was very small.

Once the temperature of the oil inside the solid state extruder or the complex reaches a solid state extrusion temperature, a hydrostatic pressure and external tensile force are applied to the solid state extruder, resulting in the extrusion by drawing force of biodegrable polymer materials. Here, the thickness of the billet may be decreased, and a spherulite crystalline structure of the materials may be converted into a fibril crystalline structure.

As the polymer chains are uniaxially arranged during the extrusion process, a 3D stereoisomeric structure may be implemented, and an orientation-induced crystallization may occur. Here, the crystalline degree may increase, along with the orientation degree.

That is, once a polymer, such as the PLA stereoisomer complex, which can form crystals is solid state extruded, thermally-induced crystallization may occur as the solid state extrusion temperature is reached. Then, a spherulite crystalline structure of the materials may be converted into a fibril crystalline structure during the solid state extrusion. By the thermally-induced crystallization, highly-oriented crystals may be formed and the entire orientation degree may be increased. These results may be checked by wide angle X-ray scattering (WAXD), DSC thermal analysis, birefringence, etc.

Hereinafter, will be explained influences of conditions of vacuum compression molding-solid state extrusion on a structure and property of the PLA stereoisomer complex. The morphology of the billet may be determined by controlling compression-molding conditions. The greater crystallinity of the billet was, greater the crystallinity and double refraction (birefringence) of a solid state extruded material were. This may increase flexural strength and flexural modulus of elasticity.

Once a billet thickness increases, a draw rate increases also. This may result in the increase of crystallinity, double refraction, flexural strength, and flexural modulus of elasticity. Once a draw speed increases, a draw rate increases. In the present invention, the draw speed increased to increase the draw rate, resulting in exhibiting similar results.

As a result of the performance of the solid state extrusion, all of flexural strength and flexural modulus of elasticity of the solid state extruded materials increased by a factor of two or more than those of the compression-molded is materials. Furthermore, brittle fracture did not occur under the condition of maximum flexural deformation (25 mm), a condition for testing flexural strength. As a result, work of rupture was greatly enhanced.

Maximum flexural strength and maximum flexural modulus of elasticity of the PLA stereoisomer complex prepared in the present invention were 400 MPa and 20 GPa, respectively, which were much greater than flexural strength (20 MPa) and flexural modulus of elasticity (1 to 5 GPa) of a cancellous bone, and were much greater than flexural strength (150 MPa) and flexural modulus of elasticity (5 to 15 GPa) of cortical bone.

Furthermore, PLLA having weight-average molecular weight more than 100,000 g/mol may undergo vacuum compression-molding/cooling/solid state extrusion in the same manner as the aforementioned method. As a result, biodegradable polymer materials capable of minimizing molecular weight loss due to thermal degradation (decomposition), and capable of having more enhanced strength may be prepared.

PLLA has a glass-transition temperature of 60° C. lower than that of the PLA stereoisomer complex (70° C.), and a melting point of about 175° C. lower than that of the PLA stereoisomer complex (230° C.). Therefore, PLLA may undergo compression-molding or solid state extrusion in a temperature range lower than that of the PLA stereoisomer complex by 20 to 50° C.

Maximum flexural strength and maximum flexural modulus of elasticity of the solid state extruded PLLA materials were 300 MPa and 15.0 GPa, respectively, which were a little lower than those of the PLA stereoisomer complex, but were greater than those of the cancellous bone. Therefore, the solid state extruded PLLA materials may be applied to materials for fixing bone.

In the present invention, the PLA stereoisomer complex for fixing spine and bone and having excellent flexural strength was prepared by enhancing the orientation degree and crystallization through vacuum compression-molding and solid state extrusion processes, and by minimizing molecular weight loss. Furthermore, a relation among processing, a structure and a physical property for implementing desired dynamics was established by controlling processing conditions such as billet crystallinity, a draw rate and a draw speed. Since various strength conditions required for bone-fixing positions inside the body can be satisfied, the biodegradable polymer materials may be variously applied to a product for fixing spine and bone.

Biodegradable polymer materials according to another embodiment of the present invention may be prepared by the method for preparing biodegradable polymer materials.

The biodegradable polymer materials may have molecular weight loss less than 20% (the molecular weight loss was measured based on weight-average molecular weight by gel-permeation chromatography), flexural strength of 200 to 400 MPa, and flexural modulus of elasticity of 5 to 20 GPa.

Alternatively, the biodegradable polymer materials may have molecular weight loss less than 20%, flexural strength of 270 to 370 MPa, and flexural modulus of elasticity of 9 to 18 GPa.

A preparation method and characteristics of the biodegradable polymer materials may be the same as those described in the method for preparing biodegradable polymer materials, and thus detailed explanations thereof will be omitted.

A product for fixing bone according to still another embodiment of the present invention may include the biodegradable polymer materials, and may be configured to fix bones including spine and femur.

The product for fixing bone may be also applied to part in the body such as spine or femur, parts which require materials of high strength.

Preferably, the product for fixing bone may be one selected from a group consisting of a rod, plate, pin and screw for fixing bone including spine and femur.

The product for fixing bone may be rods, plates, pins, screws, etc. for fixing bone, and may be applied to a part such as femur and spine requiring materials of high strength.

The present invention may have the following advantages.

Firstly, the biodegradable polymer materials prepared by the method for preparing biodegradable polymer materials may have small molecular weight loss, and may have biodegradability and high strength greater than that of cortical bone.

Secondly, the product for fixing bone may be applied to femur or spine requiring high strength. Accordingly, the product may have no corrosion in the body, may require no additional operation for removal after healing bones and tissues, and may prevent stress shielding, a phenomenon in which a part of fracture does not completely regain strength due to strength of metal and ceramic materials applied to the part of fracture is much greater than that of the body tissue or bone.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### DETAILED DESCRIPTION OF THE INVENTION

Description will now be given in detail of the exemplary embodiments, with reference to the accompanying drawings. For the sake of brief description with reference to the drawings, the same or equivalent components will be provided with the same reference numbers, and description thereof will not be repeated.

### <Preparation of PLA Stereoisomer Complex>

### EXAMPLE

### PLA Stereoisomer Complex by Supercritical Carbon Dioxide-Dichloromethane

PLLA (weight of 0.84 g) and PDLA each having weight-average molecular weight of 150,000 g/mol were put into a high-pressure reactor of 40 ml with a ratio of 1:1. The high-pressure reactor was filled with nitrogen for five minutes, and underwent vacuum processing for 1 hour at a temperature of 40° C.

An organic solvent (dichloromethane) was put into the high-pressure reactor by using a syringe, and then carbon dioxide was put into the high-pressure reactor by using a liquid pump for high pressure. Here, the carbon dioxide and the organic solvent inside the high-pressure reactor had a weight ratio of 70:30 (carbon dioxide: dichloromethane).

Based on an entire solvent including the organic solvent and the carbon dioxide, the polymers inside the high-pressure reactor had a weight ratio of 100:5 (carbon dioxide+dichloromethane: polymers).

The high-pressure reactor underwent gradual temperature-rising and pressure-rising to have an inner temperature of 85° C. and an inner pressure of 250 bar, and underwent a stirring process for five hours. Upon completion of the reaction, the reactor was open to prepare a powder type PLA stereoisomer complex.

### COMPARATIVE EXAMPLE

### PLA stereoisomer complex by solution casting

A PLA stereoisomer complex was prepared in the same manner as in the aforementioned Example except for general solution casting, and the physical property of the complex prepared in this Comparative Example was compared with that of the complex prepared in the Example.

The PLLA and PDLA used in the Example for preparing a PLA stereoisomer complex, tensile strengths of the complexes prepared in the

Example and Comparative Example, etc. are compared in the following Table 1. The tensile strengths were measured by property test equipment manufactured by Instron (Nodel 5567).

TABLE 1

| | Elongation | Tensile | Youngs |
|---|---|---|---|
| | at break | Strength | Modulus |
| Material | (%) | (MPa) | (GPa) |
| PDLA | 2.2 | 14.3 | 1.6 |
| PLLA | 2.4 | 10.9 | 1.59 |
| Comparative Example: PLA | 3.7 | 36.4 | 1.64 |
| stereoisomer complex by solution | | | |
| casting | | | |
| Example: PLA stereoisomer complex | 4.3 | 47.8 | 2.02 |
| by supercritical carbon dioxide- | | | |
| dichloromethane | | | |

Referring to Table 1, as a comparison result on tensile strengths of the Example (the PLA stereoisomer complex prepared by using a supercritical fluid), Comparative Example (the PLA stereoisomer complex prepared by general solution casting), PLLA and PLDA, the mechanical properties of the PLA stereoisomer complexes were greater than those of the PLLA or PLDA. Strength of the PLA stereoisomer complex prepared by using a supercritical fluid was the greatest, which was greater than the strength of the PLA stereoisomer complex prepared by general solution casting.

Analysis by the differential scanning calorimetry (TA2910 DSC thermal analyzer, DuPont, USA) showed that the melting point of the PLA stereoisomer complex was 230°0 C., whereas the melting point of PLLA or PDLA was 175° C. The higher melting point temperature of 50° C. or more shows that thermal stability of the PLA stereoisomer complex was superior to that of the PLLA or PLDA.

### <Steps of Molding, Cooling and Extruding>

### Example 1-1

### Steps of Molding and Cooling

PLA stereoisomer complex was prepared in the same manner as in the aforementioned Example except that PLLA and PLDA each having weight-average molecular weight of 170,000 g/mol were used.

400 g of the prepared PLA stereoisomer complex was dried for 48 hours in a vacuum state at temperature of 60° C., and then was put into a mold inside a compression molding machine (a product manufactured by Tetrahedron Corporation). Then, the mold was disposed in a vacuum bag formed of a film for high temperature and high pressure. The inside of the vacuum bag was maintained in a vacuum state, and the PLA stereoisomer complex underwent compression molding for 2 hours at temperature of 250° C.

The compression-molded PLA stereoisomer complex was cooled to room temperature (about 20° C.) at a rate of 10° C./min, and then was left at room is temperature for several hours, thereby preparing a cooled complex.

The PLA stereoisomer complex having undergone the molding step and the cooling step had weight-average molecular weight of 160,000 g/mol measured by gel-permeation chromatography, had crystallinity of 20% as a result of DSC thermal analysis, and had a crystal melting temperature of 231° C. And, the PLA stereoisomer complex had flexural strength of 30 MPa and flexural modulus of elasticity of 3.2 GPa, and exhibited brittle fracture at flexural deformation of about 10 mm.

The PLA stereoisomer complex having been compression-molded in the Example 1-1 exhibited very small molecular weight loss, in comparison with polymer materials prepared in Comparative Example 1. However, in the aspect of strength, the compression-molded material cannot be used as a material for fixing bone.

### Example 1-2

### Extrusion Step

Solid state extrusion was performed with respect to the PLA stereoisomer complex having crystallinity of 20% and prepared in the Example 1-1.

By using the PLA stereoisomer complex prepared in the Example 1-1, cylindrical billet was prepared having a diameter of 9.0 to 13.5 mm. The billet was formed in a sharp shape so that the end thereof could have the same angle of 15° as an incident angle of a die of a solid state extruder. And, a diameter of a discharge part of the die of the solid state extruder was set to 5 mm, and a draw rate was controlled.

Oil was filled in the solid state extruder, and the solid state extruder was raised to a temperature of 180° C. at rate of 4° C./min. Then, a hydrostatic pressure of 18,000 lb/in² was applied, and external tensile force was applied to the solid state extruder, thereby solid state extruding biodegradable polymer materials. Here, the draw speed was fixed to 40 mm/min.

Weight-average molecular weight of the solid state extruded biodegradable polymer materials was more than 150,000 g/mol in all samples, regardless of a draw rate changed according to a billet thickness. This means that molecular weight loss was as small as 10% or less.

Diameter of the solid state extruded materials was about 4.8 mm, which was smaller than that of the solid state extruder. This means that additional drawing by external tensile force was performed, as well as drawing inside the solid state extruder by size decrease was performed.

The draw rate of the solid state extruded biodegradable polymer materials regularly increased according to the increase of a billet thickness, thereby reaching a maximum value of 7.65. As the draw rate increased, crystallinity and double refraction (birefringence) of the solid state extruded materials increased. As a result, flexural strength and flexural modulus of elasticity increased.

The following Table 2 exhibits physical properties of the biodegradable polymer materials prepared in the Example 1-2, the properties measured by using Nodel 5567 manufactured by Instron with respect to changes of size and a structure property.

Referring to the following Table 2, when billet crystallinity was 20% and a draw speed was 40 mm/min, the biodegradable polymer materials exhibited maximum flexural strength of 320 MPa and maximum flexural modulus of elasticity of 14 GPa.

TABLE 2

| | | | | | | Flexural |
|---|---|---|---|---|---|---|
| | | | | | | Modulus |
| | | | | | Flexural | of |
| ¹⁾D_{b} | ²⁾D_{f} | Draw | Crystallinity | Birefringence | Strength | Elasticity |
| (mm) | (mm) | rate | (%) | (Δn × 10³) | (MPa) | (GPa) |
| 9 | 4.85 | 3.44 | 50 | 17.7 | 270 | 9 |
| 11 | 4.83 | 5.19 | 53.3 | 2127 | 295 | 11.6 |
| 12 | 4.76 | 6.36 | 55 | 23.9 | 310 | 12.5 |
| 13 | 4.7 | 7.65 | 59.2 | 26.7 | 320 | 14 |

Remarks)
Table 2 shows a case where billet crystallinity is 20% and a draw speed is 40 mm/min.
¹⁾D_{b} denotes a diameter of a billet.
²⁾D_{f} denotes a diameter of a discharged material, a solid state extruded rod.

### Example 2

### Extrusion Step

Solid state extrusion was performed with respect to the PLA stereoisomer complex compression-molded materials prepared from the Example 1-1 and having crystallinity of 20% .

In this Example, biodegradable polymer materials were prepared in the same manner as in the Example 1-2, except that a billet thickness was fixed to 13.0 mm and a draw speed was set in the range of 40 to 145 mm/min. That is, physical properties of the prepared biodegradable polymer materials were observed with the draw rate fixed and the draw speed changed.

When a die thickness and a billet thickness are constant, a draw rate has to be constant theoretically. However, as an experimental result, as a draw speed increased, a diameter of a solid state extruded rod continuously decreased. This resulted in a continuous increase of a draw rate. This experiment demonstrated that the draw speed influenced on the draw rate in the same conditions during the solid state extrusion. Furthermore, it could be observed that the biodegradable is polymer materials in the Example 2 exhibited small molecular weight loss less than 10%.

The following Table 3 shows physical properties of the biodegradable polymer materials having undergone solid state extrusion in the Example 2. Referring to Table 3, the biodegradable polymer materials of the present invention obtained a maximum draw rate of 9.14.

As the draw speed increased, the birefringence increased even if the crystallinity of a solid state extruded material, and flexural strength and flexural modulus of elasticity increased. Here, maximum flexural strength was 350 MPa, and maximum flexural modulus of elasticity was 16.0 GPa.

TABLE 3

| | | | | | | | Flexural |
|---|---|---|---|---|---|---|---|
| | | | | | | | Modulus |
| | Draw | | | | | Flexural | of |
| ¹⁾D_{b} | Speed | ²⁾D_{f} | Draw | Crystallinity | Birefringence | Strength | Elasticity |
| (mm) | (mm/min) | (mm) | Ratio | (%) | (Δn × 10³) | (MPa) | (GPa) |
| 13 | 40 | 4.7 | 7.65 | 59.2 | 26.7 | 320 | 14 |
| | 70 | 4.5 | 8.35 | 59.3 | 27.8 | 329 | 14.7 |
| | 110 | 4.32 | 9.06 | 59.3 | 28.9 | 341 | 15.2 |
| | 140 | 4.3 | 9.14 | 59.8 | 31.2 | 350 | 16 |

Remarks)
Table 3 shows a case where billet crystallinity is 20%.
¹⁾D_{b} indicates a diameter of a billet.
²⁾D_{f} indicates a diameter of a solid state extruded rod, a discharged material.

### Example 3

### Extrusion Step

Biodegradable polymer materials were prepared in the same manner as in the Example 2, except that solid state extrusion was performed by using a billet prepared by using the PLA stereoisomer complex (compression-molded materials) having crystallinity of 20% and prepared from the Example 1-1.

Changes of size and structural property of the biodegradable polymer materials prepared in the Example 3 are shown in the following Table 4. In the Example 3, the biodegradable polymer materials exhibited molecular weight loss less than 10%, the loss measured based on weight-average molecular weight.

Referring to the following Table 4, the draw rate regularly increased according to the increase of a billet thickness in the same manner as Example 2, which exhibited a maximum value of 7.65. As the draw rate increased, the crystallinity and birefringence of the solid state extruded material increased, and thereby the flexural strength and flexural modulus of elasticity increased.

The biodegradable polymer materials prepared in the Example 3 (billet crystallinity is 30%) exhibited maximum flexural strength of 370 MPa, and maximum flexural modulus of elasticity of 18.0 GPa. When Table 3 is compared with the following Table 4, the crystallinity and birefringence of the solid state extruded material increased as the billet crystallinity increased, resulting in higher flexural strength.

TABLE 4

| | | | | | | Flexural |
|---|---|---|---|---|---|---|
| | | | | | | Modulus |
| | | | | | Flexural | of |
| ¹⁾D_{b} | ²⁾D_{f} | Draw | Crystallinity | Birefringence | Strength | Elasticity |
| (mm) | (mm) | Ratio | (%) | (Δn × 10³) | (MPa) | (GPa) |
| 9 | 4.85 | 3.44 | 56 | 18.6 | 285 | 10.5 |
| 11 | 4.83 | 5.19 | 58.1 | 22.8 | 302 | 13 |
| 12 | 4.75 | 6.38 | 60.5 | 25.5 | 340 | 15.8 |
| 13 | 4.7 | 7.65 | 64 | 28 | 370 | 18 |

Remarks)
Table 4 shows a case where billet crystallinity is 30% and a draw speed is 40 mm/min.
¹⁾D_{b} indicates a diameter of a billet.
²⁾D_{f} indicates a diameter of a solid state extruded rod, a discharged material.

### Comparative Example 1-1

### Melt Extrusion

Polymer melt materials were prepared by putting PLLA having weight-average molecular weight of 450,000 g/mol in a single-screw extruder at a constant speed, and then by completely melting the PLLA with maintaining an inner temperature of the single-screw extruder in the range of 200 to 220° C.

While maintaining the inner temperature of the single-screw extruder in the range of 200 to 220° C., the polymer melt materials were extruded and were wound at a speed of 2 m/min, thereby preparing a cylindrical melt extruded material.

The melt extruded material exhibited weight-average molecular weight of 260,000 g/mol measured by gel-permeation chromatography, and crystallinity of 12% and a melting temperature of 175° C. measured by DSC. The melt extruded materials exhibited flexural strength of 20 MPa and flexural modulus of elasticity of 2.6 GPa.

The biodegradable polymer materials, PLLA melt extruded material prepared in the Comparative Example 1-1 exhibited great molecular weight loss, and low flexural strength and flexural modulus of elasticity, which were not suitable for fixing hard tissues.

### Comparative Example 1-2

### Solid State Extrusion

Biodegradable polymer materials were prepared by solid state extruding the melt extruded materials prepared in the Comparative Example 1-1.

The cylindrical melt extruded materials prepared in the Comparative Example 1-1 were shaped so that the end thereof could have an angle of 15°, the same angle as an incident angle of a die of a solid state extruder, thereby preparing a billet. Oil was filled in a solid state extruder, and then underwent temperature-rising to 130° C. higher than the glass transition temperature of PLLA and less than the melting point of PLLA, at a rate of 4° C./min. Then, a hydrostatic pressure of 15,000 lb/in², and external tensile force were applied to the solid state extruded.

A discharge part of the die of the solid state extruder had a diameter of 5 mm, and a draw speed of 40 mm/min.

Biodegradable polymer materials prepared in the Comparative Example 1-2 exhibited weight-average molecular weight of 240,000 g/mol measured by gel-permeation chromatography, and crystallinity of 24% and a melting temperature of 177° C. measured by DSC. The solid state extruded material exhibited flexural strength of 175 MPa and flexural modulus of elasticity of 5.2 GPa.

The PLLA solid state extruded materials (biodegradable polymer materials) prepared in the Comparative Example 1-2 exhibited flexural strength and flexural modulus of elasticity greater than those of the melt extruded materials. However, the PLLA solid state extruded materials (biodegradable polymer materials) prepared in the Comparative Example 1-2 were not suitable for fixing hard tissues, either.

### Comparative Example 2-1

### Compression-Molding

400 g of PLLA having weight-average molecular weight of 400,000 g/mol underwent vacuum compression molding for 2 hours at a temperature of 200° C., in the same manner as in the Example 1.

The compression-molded complex exhibited weight-average molecular weight of 380,000 g/mol measured by gel-permeation chromatography, and crystallinity of 10% and a melting temperature of 177° C. measured by DSC.

The compression-molded complex exhibited flexural strength of 28 MPa, flexural modulus of elasticity of 2.8 GPa, and brittle fracture at flexural deformation of about 10 mm.

The PLLA compression-molded materials prepared in the Comparative Example 2-1 exhibited molecular weight loss, which was much less than that of the PLLA solid state extruded materials prepared in the Comparative Example 1. However, the compression-molded materials were not suitable for fixing bone due to its low strength.

### Comparative Example 2-2

### Solid State Extrusion

The PLLA compression-molded materials having crystallinity of 10% and prepared in the Comparative Example 2-1 underwent solid state extrusion, in the same manner as in the Example 1-2. A size and an incident angle of an end part of a cylindrical billet were equal to those of the Example 1-2, and a draw speed for solid state extrusion was 40 mm/min.

The solid state extruded materials had molecular weight (weight-average molecular weight) more than 370,000 g/mol in all samples, regardless of a draw rate change according to a billet thickness, which exhibited small molecular weight to loss less than 10%. Furthermore, a draw rate regularly increased according to the increase of a billet thickness, resulting in a maximum value of 8.9.

As the draw rate increased, the solid state extruded materials exhibited increased crystallinity and birefringence. This resulted in the increase of flexural strength and flexural modulus of elasticity. The obtained PLLA solid state extruded materials exhibited maximum flexural strength of 250 MPa, and maximum flexural modulus of elasticity of 11 GPa.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A method for preparing biodegradable polymer materials, the method comprising:
a complex preparing step of preparing polylactide stereocomplex by using a polymer having weight-average molecular weight more than 100,000 mg/mol;
a molding step of compression-molding the complex;
a cooling step of cooling the compression-molded complex; and
an extruding step of solid state extruding the cooled complex.

2. The method of claim 1, wherein the polymer is categorized into a D-type polymer and an L-type polymer, and
wherein its constituents include a cyclic ester monomer having chiral carbon.

3. The method of claim 2, wherein the cyclic ester monomer is selected from a group consisting of lactides, lactones, cyclic carbonates, cyclic anhydrides, thiolactones and a combination thereof.

4. The method of claim 2, wherein the cyclic ester monomer is one or more selected from a group consisting of a compound represented by a following Chemical Formula 1,
[Chemical Formula 1] 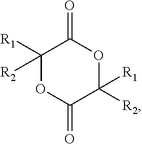
wherein the R₁ and R₂ are independently selected from a group consisting of hydrogen and an alkyl group of carbon each having the number of 1 to 4.

5. The method of claim 1, wherein the polymer includes one selected from a group consisting of PLLA(L-polylactide), PDLA(D-polylactide), PGA(polyglycolide), PLLA/PGA(polyglycolic acid), PDLA/PGA, PLLA/PCL(polycaprolactone), PDLA/PCL and a combination thereof.

6. The method of claim 1, wherein the polymer has weight-average molecular weight of 100,000 to 1,000,000 g/mol.

7. The method of claim 1, wherein in the complex preparing step, complex is prepared by using a solvent, in a supercritical fluid system having a temperature of 25 to 250° C. and an atmospheric pressure of 40 to 700 bar.

8. The method of claim 1, wherein in the molding step, a compression-molding temperature is in the range of 150 to 280° C.

9. The method of claim 1, wherein in the step of cooling, a cooling speed for cooling the compression-molded complex is in the range of 1 to 100° C./min.

10. The method of claim 1, wherein in the step of cooling, the compression-molded complex is cooled to 20 to 150° C.

11. The method of claim 1, wherein in the step of extruding, a discharge part of a die of the solid state extruder has a diameter of 1 to 20 mm.

12. The method of claim 1, wherein in the step of extruding, the solid state extrusion is performed by setting an incident angle of a die to 5 to 60°.

13. The method of claim 1, wherein in the step of extruding, an extrusion temperature is in the range of 40 to 170° C.

14. The method of claim 1, wherein in the step of extruding, an extrusion pressure is in the range of 5,000 to 30,000 lb/in².

15. The method of claim 1, wherein in the step of extruding, a draw rate is two or more.

16. The method of claim 1, wherein in the step of extruding, a draw speed is in the range of 5 to 300 mm/min.

17. Biodegradable polymer materials prepared by claim 1.

18. The biodegradable polymer materials of claim 17, wherein the degradable polymer materials have molecular weight loss less than 20%, flexural strength of 200 to 400 MPa, and flexural modulus of elasticity of 5 to 20 GPa.

19. A product for fixing bone, the product having the biodegradable polymer materials of claim 17, and configured to fix bones including spine and femur.

20. The product for fixing bone of claim 19, wherein the product is selected from a group consisting of a rod, plate, pin and screw.
